(19) United States
(12) Patent Application Publication
(10) Pub. No.: US 2014/0010992 A1
(43) Pub. Date: Jan. 9, 2014

(54) Chemical Process for Obtaining Anti-Reflective Glass, Comprising Immersion in an Acid Solution, for Simultaneous and Continuous Production

(71) Applicant: Juan Luis Rendon Granados, Celaya (MX)

(72) Inventor: Juan Luis Rendon Granados, Celaya (MX)

(21) Appl. No.: 13/860,469

(22) Filed: Apr. 10, 2013

Related U.S. Application Data
(63) Continuation of application No. 11/792,641, filed on Feb. 9, 2010, now abandoned.

(30) Foreign Application Priority Data
Dec. 10, 2004 (MX) GT/A/2004/000019

(51) Int. Cl. C03C 15/00

(52) U.S. Cl. CPC C03C 15/00
USPC 428/141; 156/345.11; 216/24

(57) ABSTRACT

A chemical process for obtaining anti-reflective glass, comprising immersion in an acid solution, for the simultaneous and continuous production of one or more parts and/or sheets of glass having standard, special or variable dimensions, thicknesses, colours, uses and applications.

### BACKGROUND OF THE INVENTION

1. Field of Invention

An inventive production process for anti-reflective glass comprising an immersion in chemical solutions to increase production efficiency than the already known processes is disclosed. Such processes are referred in the background art section below. The inventive process minimizes materials waste since treated glass sheets are commercially available of 180 cm×180 cm, thus minimizing production costs due to a higher production and lower safety risks since there is no direct manipulation during processing; thus, obtaining a product that surpasses the current ones since the anti-reflective treatment is clone on both sides of the glass sheet (tinned side and atmospheric side) simultaneously and continuously on several glass sheets and/or pieces at the same time. The acid solutions are always on the chemical solution containers that are coated with high density polyethylene sheets or polypropylene of 0.835 cm width that are resistant to acids that are used in the process, and the glass sheet containers that are used for transportation and immersion of the glass sheets and/or pieces are also coated with an accelerated thyxotropic polyester resin in conjunction with the catalyst methyl-ethyl-ketone peroxide in dimethyl phthalate at 50%; these coatings allow transportation and immersion of glass sheets for the different chemical products solutions.

2. Background Art

For obtaining products from float glass we have used sheets of flat float glass which are produced by flotation of malted glass on a bed of tin as shown in FIG. 1. FIG. 1 shows a lateral view of this process of manufacture of float plane glass; this process comprises the raw materials that constitute the float glass are mixed previously before entering the melting furnace (1), where liquid glass is formed (2), this glass goes towards the tin bath (3) where the glass floats on the liquid tin bed (4) forming the sheet of glass with the required thickness, (5) then cooled for later cut according to the required dimensions. The glass sheets have two sides, one of them was in contact with liquid tin (tinned side) and the other one was in contact with the atmosphere (atmospheric side) in the melting furnace.

To date, the production of anti-reflective glass is performed by placing the glass piece on a table with the atmospheric side upward and putting a wax liner along the sides to place a paste or an acid solution to have an anti-reflective finish. The acid solution is contacted with the glass for a period of time and then finally washed to eliminate acid residues.

This already-known method for the production of one-side anti-reflective glass does not allow processing of large glass pieces; it only allows processing of one sheet at a time and on one side (atmospheric side). There is an associated handling risk and large materials waste. Because of this, there is a low productivity and high production costs in addition to health risks associated with acid handling producing a low-quality material. Also, this already-known process does not allow chemically-treating the tinned side since fin residues avoids chemical reaction with the acid solution.

### SUMMARY OF THE INVENTION

In order to obtain higher production volumes, improve product qualify and minimize physical, environmental and personnel risks this invention was thoroughly designed in order to protect it by the present patent. The immersion process itself, design and coating of the chemical solution containers, glass sheet containers, and the formulation of the chemical solutions used in the production process of anti-reflective glass sheets are the main subjects of this invention in addition to the product obtained by the present invention; anti-reflective glass. In accordance with the invention, there is described and claimed herein is a chemical process for obtaining float glass with anti-reflective finish, comprising immersion in an acid solution, for simultaneous and continuous production in a total or partial sheets of glass for producing one or several pieces of glass with different dimensions, thicknesses, colors, standard uses and applications; said sheets of glass may be treated in both sides, atmospheric side and tinned side, or just in one of them; of indistinct manner. The general process consider its planning of use, design, development, construction, materials used and application for the production, its methodology comprises reception of the pieces or thin sheets of glass, loading the pieces or thin sheets of glass towards the containers, processing of the pieces or thin sheets of glass by immersion in acid solution, drying of the pieces or thin sheets of glass and unloading the pieces or thin sheets of glass of its containers.

### BRIEF DESCRIPTION OF THE ACCOMPANYING DRAWINGS

FIG. 1. Lateral view of the production process for flat floated glass.

FIG. 2. Isometric view of the glass pieces and/or sheets container.

FIG. 3. Loading and unloading system for glass sheets.

FIG. 4. Vertical loading of the glass sheets.

FIG. 5. Angle-like loading of the glass sheets.

FIG. 8. Horizontal loading of the glass sheets.

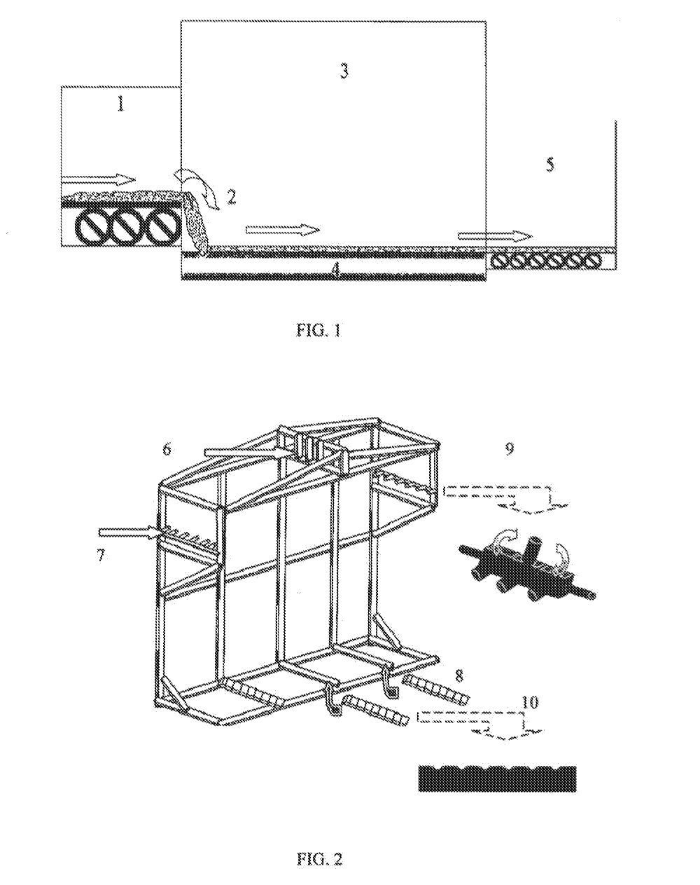

FIG. 7. Loading and unloading of the glass sheets in the glass pieces and/or sheets container.

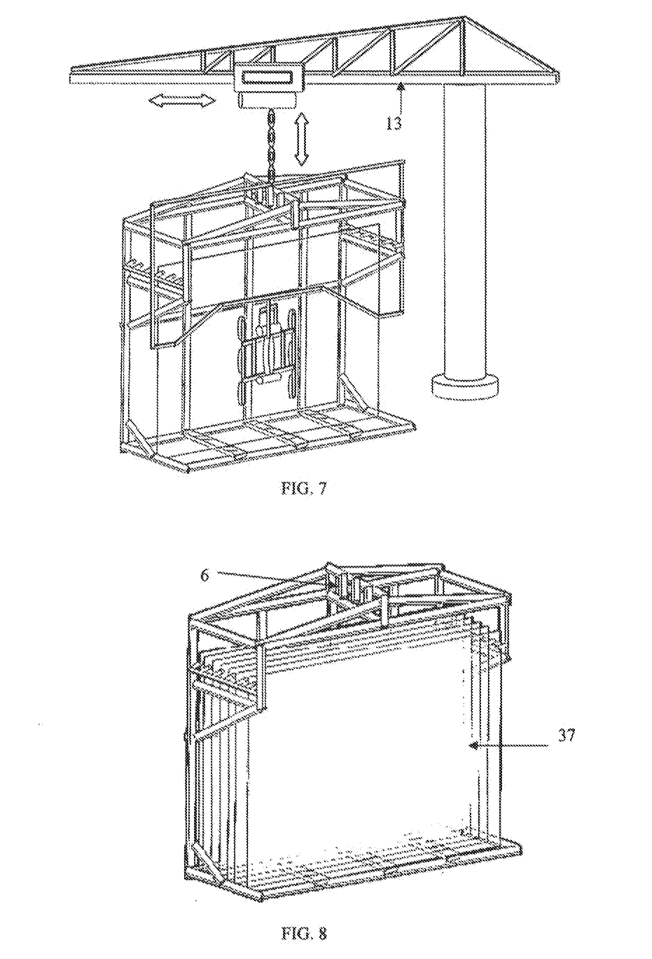

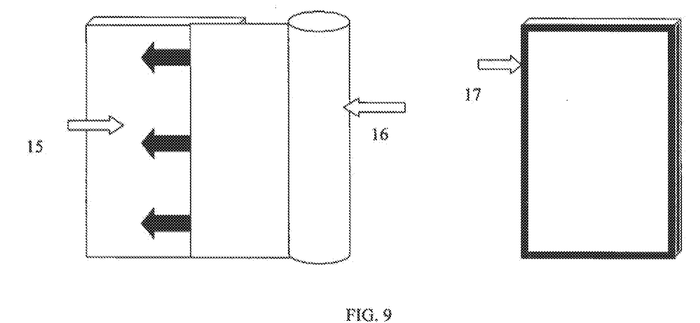

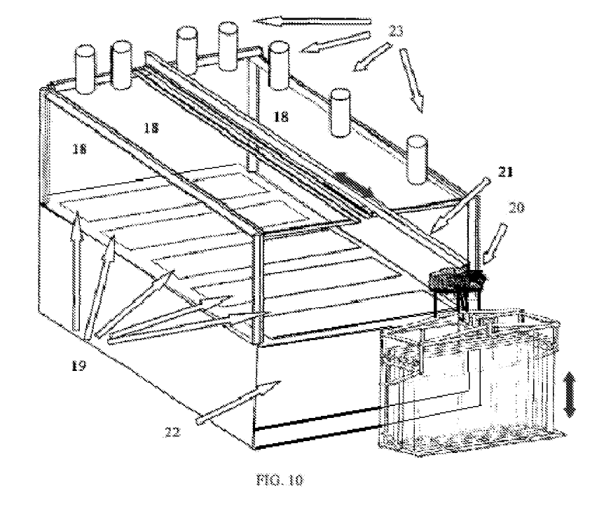

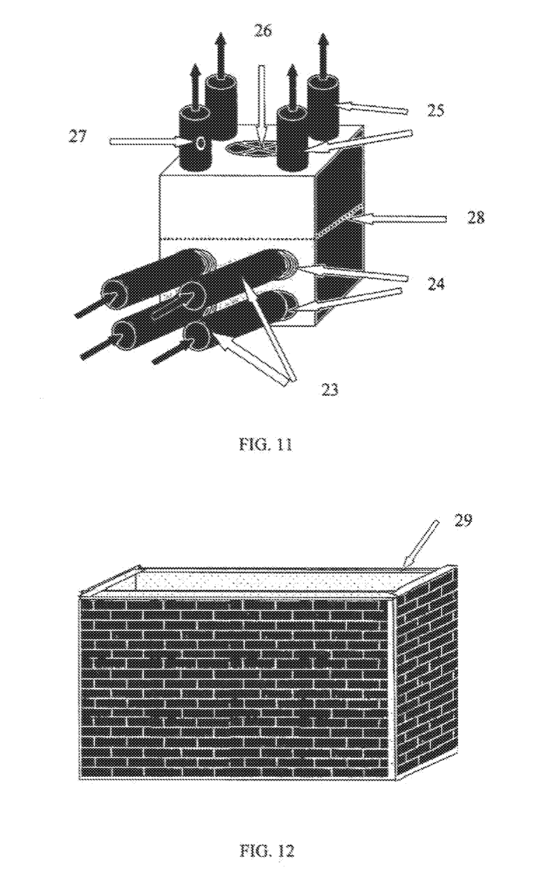

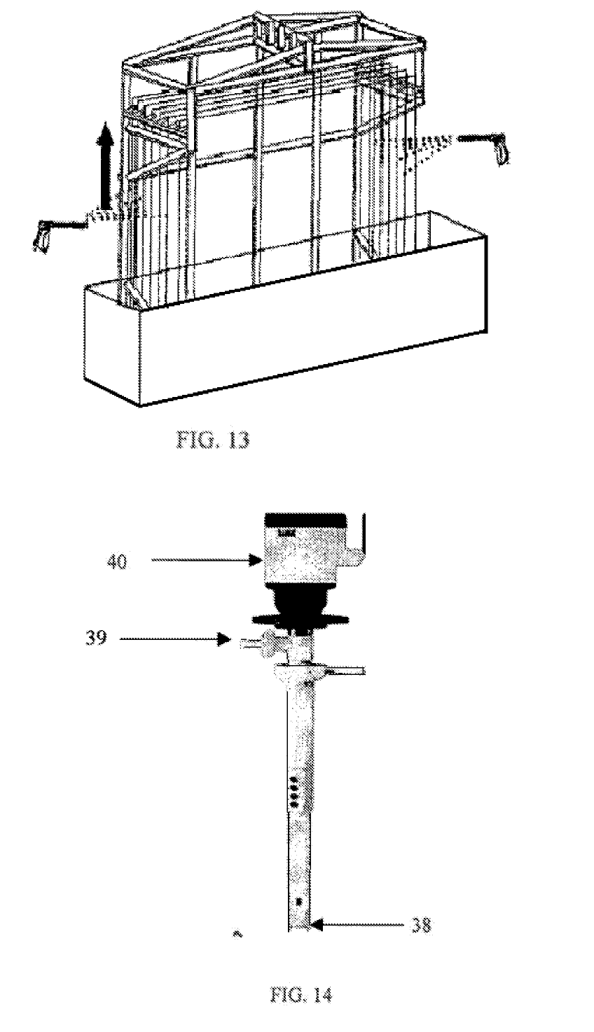

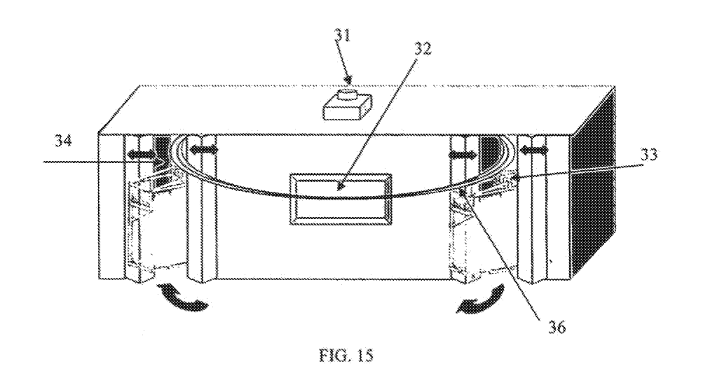

FIG. 8. Glass pieces and/or sheets container with loaded glass,

FIG. 9. Mirror finished side protection system.

FIG. 10. Immersion process.

FIG. 11. Gas washer (degassing).

FIG. 12. Chemical solutions container.

FIG. 13. Hydro pneumatic wash system.

FIG. 14. High density polyethylene or polypropylene pneumatic pump.

FIG. 15. Continuous dryer “tunnel” type.

### DETAILED DESCRIPTION OF THE PREFERRED EMBODIMENTS

The present patent is intended to protect a chemical process for producing glass with an anti-reflective finish, comprising immersion in an acid solution, for simultaneous and continuous production of one or several glass pieces and/or sheets with varying dimensions, thicknesses, colors, standard uses and applications; such anti-reflective glass may be treated on both sides in the production process. The produced glass of the present process and its characteristics, in addition to the equipment, accessories, and materials specially designed for this process is described in detail below.

The chemical process for obtaining glass with anti-reflective finish in an acid solution for continuous and simultaneous production of one or several glass pieces and/or sheets with dimensions, widths, colors, standard uses and applications has the following stages:
a) reception of glass pieces and/or sheets,
b) loading of the glass pieces and/or sheets into the glass containers,
c) processing of the glass pieces and/or sheets by immersion in acid solution,
d) drying of the glass pieces and/or sheets, and
e) unloading of the glass pieces and/or sheets from its containers.

a) Reception of the Glass Pieces and/or Sheets

A stock of glass pieces and/or sheets is received in specially designed trucks. An adapted crane is used to unload the truck; this “bridge” type crane has 3 tons in capacity, 15 meters in width, 20 meters in length and 5 meters in height; it has a microelevation speed of 0.5 meters per minute, elevation speed is variable from 0.5 meters per minute to 5.2 meters per minute; also a motor reducer speed is variable from 5.1 meters per minute to 15.4 meters per minute. The same “bridge” type crane is used for loading the packages of anti-reflective glass on trucks, for delivering, distributing and transporting them. The crane used for loading and unloading allows fast processing of the glass. If is noteworthy that the absence of the above mentioned crane would increase operations time and associated costs. Also, physical risk for the personnel and the materials is minimized. Glass pieces and/or sheets are unloading from to the truck to be stored in special containers for further processing.

b) Loading of the Glass Pieces and/or Sheets into the Glass Containers

To convey glass pieces and/or sheets during the production process, a specially designed container is used to allow us fast processing of the glass on both sides (tinned side and atmospheric side) simultaneously. This way allows a higher production rate in contrast to the already-known traditional process; it also minimizes personnel risk since there is no direct manipulation. Glass pieces and/or sheets are vertically placed in the special container as shown in FIG. 2 and by means of a chain-hoist; the glass is ready for the immersion process.

The specially-designed containers are made of rectangular tubular steel profile (ptr) of 2.54 centimeters of thickness and its unique design can hold static and dynamic stresses that are present during the production process. The glass pieces and/or sheets container has 180 centimeters in height, 180 centimeters in length and 39 centimeters in width; into the glass sheets can he collocated until 18 glass sheets of 1800×1800×2 millimeters (commercial dimension), but the container capacity can receive the sheets with any kind of thicknesses, dimensions and colors.

The lateral framework container has movable simple pivots (7) are made of polypropylene or high density polyethylene plate and bar, because they are resistant to the acid attack, each one of said pivots can turn on its axis, to pot on vertical position for receiving the glass sheets, and soon happen pass to a horizontal position to maintain them (9). The superior position of container has 3 hooks to balance the container load and to hold said container onto traveling crane “bridge” type for transporting and immersing the glass sheets in to the solution containers; its gravity center was calculated for stabilizing totally the container. The inferior position of container has 3 supports (8) made of polypropylene or high density polyethylene plate resistant to acid attack; each support has 34 centimeter in length and 1.27 centimeters in height and they are grooved with 2.5 centimeters between separation of grooves in which the glass sheets are collocated in vertical form.

The glass pieces and/or sheets container resist the chemical treatment by having a covering with an accelerated thyxotropic polyester resin in conjunction with the catalyst methyl-ethyl-ketone peroxide in dimethyl phthalate at 50%.

The loading of glass pieces and/or sheets is by storage into the trestle, ether manually or pneumatically. The pneumatic way consists of 6 pneumatic cupping glasses connected to a vacuum pump of ¼ of H.P. with capacity until 500 kilograms (11), the cupping are located on framework specially designed to permit if entrance to the container (12), said cupping system has flexible movements due to turn 360° since they are placed to an endless bullet mold by means of a cable to the chain-hoist (14); said chain-hoist is in the riel of “flag” type crane (13), this cupping system is versatile because take the glass sheets in vertical form (FIG. 2), horizontal form (FIG. 6), or any ankle (FIG. 5), and runs in both directions from one side to another to take or to deposit the glass sheets by means the riel (13) to collocate said sheets into container (FIG. 7).

The crane enlistment the container once the container (8) is loaded with the glass sheets, and is ready for the process (FIG. 8).

Approximately, we process 230 Kg per container in 15 minutes. It means 184 meters² of glass sheets of 2 mm of thickness per hour, this capacity may be increased according to production necessities.

This container may be process pieces or sheets with different dimensions, colors, thicknesses, by both sides (atmospheric side and tinned side) including mirror sheets simultaneously: the FIG. 9 shows how we can protect the paint side in a mirror sheet (15), applying auto-adherible plastic resistant to acid attack film type (16) with U.V. protection, when the anti-reflective finish is made on one side of mirror sheets or float glass sheet we can join two mirror or float sheets or one side of mirror or float sheets can protected with an adhesive acrylic type on the paint side and re-forced the edges with special tape (17) used In air conditioning ducts.

c) Processing of the Pieces and/or Glass Sheet by Immersion in an Acid Solution

The chemical process for obtaining anti-reflective glass by immersion in an acid solution for simultaneous and continuous production, of one or several pieces and/or sheet of glass of dimensions, thicknesses, colors, uses and standard, special and variable applications (FIG. 10); it has had in sequence a series seven containers of chemical solutions (19) of 239 centimeters in length, 54 centimeters in width, 20 centimeters in depth these dimensions are adequate for collocating into the container the glass sheets, but the measures are changed depending on the production necessities.

All these containers of chemical solutions are isolated by means of an encapsulated system by means of a wall done of square tubular steel profile covered with polyethylene (18), with the purpose of avoiding the acid gas emanation increasing the security degree, preventing the equipment corrosion and splits of the solutions.

Said encapsulated system has the gas exit by means of eight extractors transporting the acid steam (23) towards the gas washers (FIG. 11), having an absorption and neutralization of these acid steam in a volume of 64000 cubic meters per hour in all system, both gases washing have four extractors towards gas washers (FIG. 11); this encapsulated system have perfect sealing by means of side awing in the curtain that can automatic or manual form through a chain-hoist (20) with variable speed from 3 to 20 meters per minute and its optimal velocity is from 5.1 to 19.3 meters per minute, passing the glass container (FIG. 8) towards chemical solutions (19). When the glass container supported with the chain-hoist entrance and exit to encapsulated system, the awing curtain up or down slide by means of motor reducers of ¼ H.P.

Said encapsulated system (18) has four extractors (24) of 800 cubic meters per hour each one, the gas are extracted and transported by ducts (23) toward gas washers (FIG. 11) neutralizing them with a solution of sodium hydroxide at 4% with a nominal volume of 220 liters (28); this extraction allows us to unload to the outer atmosphere a neutral and inert gas by the exit chimneys (25); said chimney has a gas sampling port (32) to evaluate the process analyzing it every 6 months according to the environmental Mexican norms (NOM 02). The capacity total of the washers is of 1000 liters. In order to renew and to maintain the level of the washing solution the system has an access floodgate (26).

Each chemical solution container (19) has a volume of 2700 liters for assuring the total glass covered when the immersion is made. Said solutions containers (19) have a system of agitation and movement with compressed air provided by a 135 compressor of psi of 30 amperes and 2.5 H.P. for homogenizing the solution and removing the accumulated remainders.

These chemical solutions containers are over the level of the floor (with 3 m in elevation) if is necessary a movable stair could be occupied; these seven containers are constructed of concrete armed with a double wall of partition or brick (FIG. 12); they were constructed calculating the support mechanical, static and dynamic efforts and pressures exerted on the walls and floor by the fluids contained within, its volume is 3000 liters with a security factor of 80%. The chemical solutions containers are covered with plate of polypropylene or high density polyethylene 0.635 cm. of thickness (29) that makes resistant to the acid attack because these materials are inert to used acids, allowing the storage of the solutions per prolonged time, included several decades.

For the transport and immersion of the glass of pieces and/or sheet container, using a chain-hoist of 0.5 H.P. of variable speed for elevation and translation (3 meters per minute until 20 meters per minute), said chain-hoist has a capacity of 500 Kg and 6 meters of elevation (20), which run around the riel (21) for transporting the glass container toward the solutions container in the sequential manner by stages. The stages of the process are described following:

Step 1 in the immersion process.—The first chemical solutions container has an acid solution prepared with 17% of hydrofluoric acid at 70%, 53% of hydrochloric acid at 30%, 23% of dextrose monohydrated sugar and 7% of ammonium bifluoride anhydrous. These components are mixed in this order; it is the optimal formulation, for the treatment for obtaining the anti-reflective finish; the reagent time is at least by one hour, The concentration can have the following range: from 12% to 22%, 48% to 58%, 17% to 28% and 5% to 13% respectively, without affecting the process. It is necessary to monitor its concentration, its acidity is between 14 a 19 miliequivalents per liter, its electrical conductivity is from 900,000 to 2,100,000 microhms, the reagent time is form 20 to 185 seconds, the immersion velocity can be from 5.1 to 19.3 meters per minute, the parameters vary depending on glass type, and thickness; in this container the finish anti-reflective is made.

Step 2 in the immersion process.—The second container has current water for rising the glass pieces and/or sheets eliminating the acid residues. This container must foe has the following parameter: electrical conductivity until 400,000 microhms.

Step 3 in the immersion process.—The third chemical solution container has a neutralizing solution prepared with sodium hydroxide at 4%; said container must be has the following parameters: pH 7.5, the electrical conductivity is until 400,000 microhms and the reagent time of immersion is from 30 to 180 seconds depending on the pH, because the reaction must be stopped.

Step 4 in the Immersion process.—The forth chemical solution container has current water for rising the glass pieces and sheets for eliminating the acid residues and the residues of neutralizing solution. This container has the following parameters: electrical conductivity until 100,000 microhms for assurance the treatment. This container has a hydro-washing system by sprinkling deionized wafer less than 10 microhms, with automatic or manual way at 3000 pressure pounds of 5 H.P. (FIG. 13), When the glass container is leaving the solutions container the deionized water is sprinkled by hydro-washing system.

Step 5 in the immersion process.—The fifth chemical solution container has a washer solution prepared with deionized water (less than 10 microhms) that for its electrical conductivity eliminate the acid residues and residues of neutralizing solution, guarantee the safety use of the anti-reflective glass.

The sixth and seventh chemical solution containers must he ready for any eventuality during the process.

We have a tank covered with high density polyethylene with automatic shaking or manual for preparing the solutions used during the process; its capacity is of 1100 liters however must be increasing it according to production necessities. The raw material is deposited info the tank and when the solution is ready it pass to its containers by means of special pumps covered with polypropylene, PVC, or high density polyethylene; as is shown in the FIG. 14.

For raising deionized water used during the process we have a special equipment that deionizer water by ionic interchange (cationic-anionic) with a flux to 22.7 liters per minute, however it could be increasing it.

d) Drying of the Glass Pieces and/or Glass

After chemical processing, the anti-reflective glass pieces and/or sheet are passed from its container to a continuous dryer “tunnel” type; said continuous dryer is specially designed in function of our necessities (34) which consists of a motor reducer pf 2 H.P. for traction and transport the glass pieces container from its entrance to its exit; if can be a heating system fey means of L.P. gas, natural gas and/or electrical resistance with internal ventilation; the temperature process and velocity are variable; its temperature at work is from 35 to 60° C., and the time dried is fro 2 to 3.5 hours depending of the production. The capacity of continuous dryer is for 9 glass sheets containers, it means 2100 Kg of glass. This dryer permit to increase the process productivity and efficiency due to the humidity marks are diminished. The ceiling dryer has a humidity extractor (31), also has a window (32) to watch the dried process, its entrance and its exit are sealed through slide doors. The dryer has a transport reil (38) wherein the containers are hanged.

The drying of the anti-reflective glass pieces and/or sheets also can become at room temperature by means of a vertical or horizontal washing-dryer machine, including conditions at room temperature.

e) Unloading of the Glass Pieces and/or Sheet from its Containers

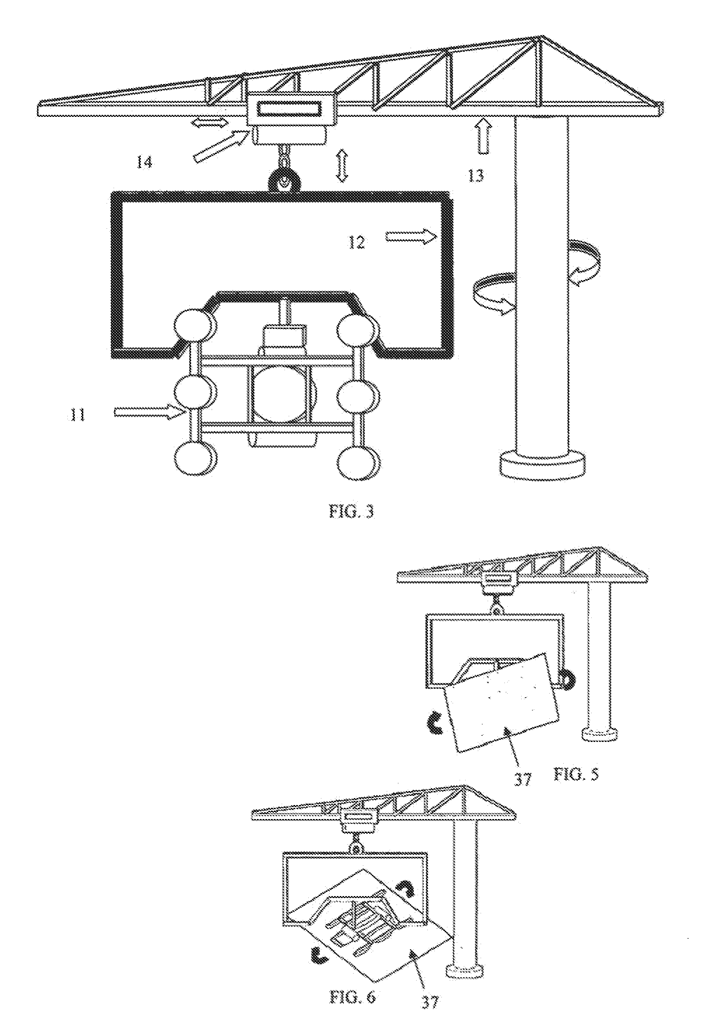

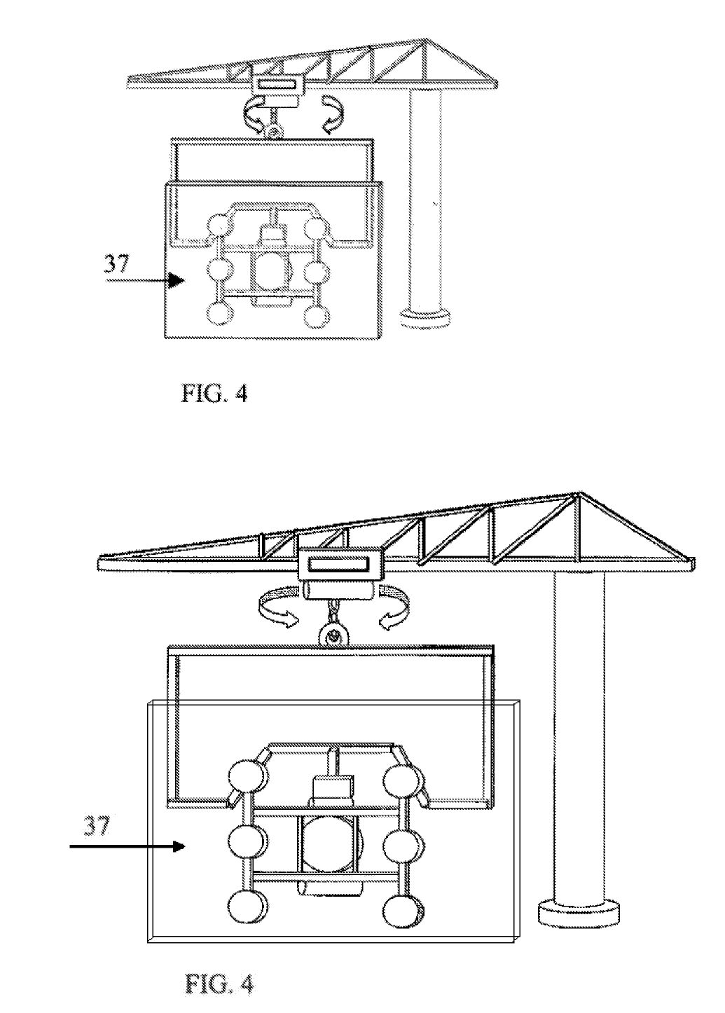

Once dried the anti-reflective glass pieces are transported toward the trestle for delivering and distributing them. The unloading of the anti-reflective glass from its containers can be by means of cupping pneumatic system whose 6 cupping are connected to a vacuum pump of ¼ H.P. which is comprised in the system of crane “flag” type (FIG. 3), with capacity of up to 500 kilograms according to the production necessities.

For monitoring, sampling, analyzing and controlling the parameters established, each chemical solution container has a laboratory equipped support fully process, with the following equipment: conduct-meters of different scales depending on the solutions, electronic and manual potentiometers and lab material

Using this chemical process by immersion for treatment total or partial glass with anti-reflective finish by immersion in acid solution for simultaneous and continuous production of one or several pieces and/or sheet of glass of dimensions, thicknesses, colors, uses and standard, special and variable applications, the process is optimized reutilizing the waste materials; it allows to have a high volume of production because anti-reflective one or several pieces and/or sheets is produced on one or both side of the float glass; indistinct manner. The process diminished the risks to acid manipulation because the personnel have been trained about dangerous of the acid solutions, how combat the fire and residues, besides each stage is carefully made, mainly by using an encapsulated system to protect the solutions containers avoiding the acid gas emanation. For example, the water process is discharged with previously neutralization, avoiding all kind of risk.

The process established in this request is highly better than the already-known process, for example the traditional process only anti-reflective the atmospheric side and the finishes is not homogeneous because the experience of operator to applicant the past or solutions is critical; in contrast our process the finished is higher homogeneous and if can be on one or both sides included tinned side.

All and each stages of process are made at room temperature, at atmospheric pressure and relative humidity except the furnace “tunnel” type.

What is claimed is:

1. A chemical process for obtaining float glass having an anti-reflective finish, comprising immersion in an acid solution, for simultaneous and continuous production in a total or partial sheets of glass for producing a variable number of pieces of glass having different dimensions, thicknesses, colors, standard uses and applications, said sheets of glass being treated on at least one side of an atmospheric side or a finned side, comprising:
a) reception of the pieces or thin sheets of glass;
b) loading of the pieces or thin sheets of glass towards the containers;
c) processing of the pieces or thin sheets of glass by immersion in an acid solution;
d) drying the pieces or thin sheets of glass; and
e) unloading the pieces or thin sheets of glass from the containers.

2. The chemical process for obtaining float glass with anti-reflective finish as in claim 1, said immersion step further comprising treating the pieces of glass with the following several solutions in sequence:
a) washing and cleaning solution;
b) acid solution;
c) rinsing solution for rinsing;
d) acidified solution and washed stop solution;
e) rinsing solution for rinsing;
f) washing solution;
g) an optional second washing solution.

3. The chemical process for obtaining float glass with anti-reflective finish as in claim 2, wherein the acid solution further comprises:
a) from 12% to 22% of hydrofluoric acid at 70%;
b) from 48% to 58% of hydrochloric acid at 30%;
c) from 5% to 25% of dextrose monohydrate sugar; and
d) from 5% to 13% of ammonium bifluoride anhydrous,
thereby producing an acidify of 14 to 19 miliequivalents per liter, and an electrical conductivity of from 900,000 to 2,100,000 microhms,
wherein the speed of immersion of the glass pieces in the acid solution Is of from 5.1 to 19.3 meters per minute and the time of immersion of the sheets of glass within the solution is from 20 to 185 seconds.

4. The chemical process for obtaining float glass with anti-reflective finish as in claim 2, wherein the rinsing solution for rinsing in steps c) and e) is made by immersion in a stream of water flowing in the containers for eliminating the acid residues and residues of neutralized solution.

5. The chemical process for obtaining float glass with anti-reflective finish as in claim 2, where in the neutralizing and Inhibiting solution is prepared with sodium hydroxide at 4%.

6. The chemical process for obtaining float glass with anti-reflective finish as in claim 2, wherein the rinsing step e) further comprises rinsing by immersion and sprinkling with deionized water.

7. Float glass with anti-reflective finish obtained by immersion in an acid solution for producing one or several pieces and/or sheets the simultaneous and continuous manner, which finishes on one or both sides (atmospheric side and tinned side); glass sheets having standard, special .or variable dimensions, thicknesses, colors, uses and applications

8. A system to facilitate use of a chemical process for obtaining float glass with anti-reflective finish by immersion in acid solution for simultaneous and continuous production of one or several pieces or thin sheets of glass of any kind of dimensions, thicknesses, colors, standard uses and applications; said sheets of glass capable of being treated on at least on of two sides, an atmospheric side and a tinned side; the system comprising;
a) Traveling “bridge” type crane for loading and unloading the pieces of glass;
b) System “flag” type for loading and unloading the pieces of glass;
c) Container for sheets of glass;
d) Crane and chain-hoist with variable-speed;
e) Containers of chemical solutions;
f) Encapsulated of the system;
g) System of extractors, transporters and washers of gas;
h) Drying chamber; and
i) Pumps and special equipment for handling the chemical solutions.

9. A system to facilitate use of the chemical process for obtaining float glass with anti-reflective finish by immersion as in claim 8, which traveling crane “bridge” type has 3 tons of capacity, 15 meters of width, 20 meters of length and 5 meters of height; a microelevation of 0.5 meters per minute, its speed of elevation is variable from 0.5 meters per minute to 5.2 meters per minute; has variable speed motor reducers transferring speed from 5.1 meters per minute to 15.4 meters per minute, the crane being capable of loading the anti-reflective glass packages on trucks for delivery and distribution.

10. The system to facilitate use of the chemical process for obtaining float glass with anti-reflective finish by immersion as in claim 8, wherein the system “flag” type for loading and unloading comprises: a system of 6 pneumatic suction cups connected to a vacuum pump of a ¼ of H.P. with capacity of up to 500 kilograms, pneumatic suction cups are capable of being placed on a special frame designed to put in if the container of pieces of glass; and are capable of flexible movements and turning through a 360° rotation, because they are placed to an endless bullet mold to a chain-hoist by cable, this permit them horizontal and vertical movements on the rail of “flag” type system. This system is sufficiently versatile to be able to take the pieces of glass in vertical and horizontal form, or in any angle, besides if puts the glass sheets in the container throughout rail.

11. The system to facilitate use of a chemical process for obtaining float glass with anti-reflective finish by immersion as in claim 8, whose the glass pieces and/or sheets container were designed with the following technical and functional specifications: rectangular tubular steel profile (ptr) of 2.54 cm having a covering with an accelerated thyrotropic polyester resin in conjunction with the catalyst methyl-ethyl-ketone peroxide in dimethyl phthalate at 50%, for avoiding the acid attack. Also it has movable pivots made in plate and bar of high density polyethylene placed on the superior lateral framework of the container of glass pieces; the inferior position has a grooved bar or plate of polypropylene or polyethylene of 34 cm in length and 1.27 cm in height.

12. The system to facilitate use of a chemical process for obtaining float glass with anti-reflective finish by immersion as claim in 8, whose the crane and the chain-hoist has variable-speed of elevation from 3 m/minute to 20 m/minute and its speed of transferring is variable from 3 m/minute to 20 m/minute.

13. The system to facilitate use of a chemical process for obtaining float glass with anti-reflective finish by immersion as in claim 8, whose chemical solutions containers used in the process are constructed by brick, concrete and steel and have a special thickness of wall, have a cement layer of special thickness and a biphenolic resin layer with fiber glass of special thickness. They have a covering that resist the acid attack made by a plate of polypropylene of 0.635 cm. of thickness, these welded plates form a container or plate of polyethylene of high density. The containers have a stirring system with movement for homogenizing the chemical solutions through compressed air provided by a compressor of 135 psi, 30 amperes and 2.5 H.P.

14. The system to facilitate use of a chemical process for obtaining float glass with anti-reflective finish by immersion as in claim 8, comprising a encapsulated structure made by an structure of polyethylene with rectangular tubular steel profile (ptr) of 2.54 cm; this encapsulated structure permits to control the gas emanation.

15. The system to facilitate use of a chemical process for obtaining float glass with anti-reflective finish by immersion as in claim 8, comprising a set of extractors, transporters and gas emanation; the washers consist of two gas washers with four extractors each one, each extractor has an extraction of 800 cubic meters per hour; whose transport the gas emanation through the ducts until gas washer for neutralizing them, at the rate of 6400 cubic meters per hour. The neutralizing solution has sodium hydroxide to 4%; the operation volume is of 200 liters and permits to eliminate neutral and no reactive gas emanation through the chimneys; said chimneys have a port for analyzing gas samples, in order to renew and to maintain the level of the neutralizing solution and its concentration.

16. The system to facilitate use of a chemical process for obtaining float glass with anti-reflective finish by immersion as in claim 8, whose continuous dryer “tunnel” type consists of a motor reducers of 2 H.P. for fraction and transporting the containers through the continuous riel; its heating is on base of L.P. gas, natural gas and/or electrical resistance, the range of work temperature is from 35° C. to 60° C., during 2 to 3.5 hours. Its capacity is of 9 glass containers, approximately at 2100 Kg. Another form for drying the finished pieces of glass is employing to room temperature and using a horizontal or vertical washing-dried machine.

17. The system to facilitate use of a chemical process for obtaining float glass with anti-reflective finish by immersion as in claim 8, whose pumps and special recipient are made with PVC and high density polyethylene or propylene, they are resistant to the acid attack.
